(19) United States
(12) Patent Application Publication
(10) Pub. No.: US 2007/0072077 A1
(43) Pub. Date: Mar. 29, 2007

(54) Lithium secondary battery, negative electrode therefor, and method of their manufacture

(75) Inventors: Yasuyuki Kusumoto, Kobe-shi (JP); Nobuhiro Sakitani, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/527,713

(22) Filed: Sep. 27, 2006

(30) Foreign Application Priority Data
Sep. 29, 2005 (JP) 2005-285280

(51) Int. Cl. H01M 4/38; H01M 4/62

(52) U.S. Cl. 429/218.1; 429/224; 429/221; 429/223; 429/217; 29/623.1

(57) ABSTRACT

A practical lithium secondary battery is provided having a greater battery capacity than in the case of using particulate graphite as its negative electrode active material but a less electrical resistance of its negative electrode mixture layer than in the case of using particulate Si as the negative electrode active material. The lithium secondary battery also exhibits good charge-discharge cycle performance. The lithium secondary battery is furnished with a negative electrode having negative electrode current collector and a negative electrode mixture layer that contains a Sn-based particulate negative electrode active material and a negative electrode binder. The negative electrode binder is melt-bonded to the Sn-based particulate negative electrode active material and/or the negative electrode current collector, and the Sn-based particulate negative electrode active material is made of an intermetallic compound represented as Sn_{X}M_{1-X}, where 1>X≧1/2 and M is Mn, Fe, Co, or Ni.

### BACKGROUND OF THE INVENTION

1. Field of the Invention

The present invention relates to lithium secondary batteries and methods of manufacturing the batteries, and more particularly to negative electrodes for lithium secondary batteries and methods of manufacturing the electrodes.

2. Description of Related Art

In recent years, lithium secondary batteries using a non-aqueous electrolyte and performing charge-discharge operations by transferring lithium ions between positive and negative electrodes have been utilized as a new type of high power, high energy density secondary battery. In this type of lithium secondary battery, the negative electrode generally has a structure in which a negative electrode current collector and a negative electrode active material layer containing graphite are stacked. In recent years, much research has been conducted on negative electrode active material to increase the capacity of a lithium secondary battery. The use of materials containing Si (silicon) or Sn (tin) has been investigated as a candidate for negative electrode active material that will replace graphite. Si in negative electrode active material is capable of forming a compound represented by the formula Li₂₂Si₅, and Sn in negative electrode active material is capable of forming a compound represented by the formula Li₂₂Sn₅. Accordingly, negative electrode active materials containing Si or Sn can intercalate a greater amount of Li (lithium) than graphite can.

The use of a negative electrode having a negative electrode active material layer that contains a binder and a particulate negative electrode active material containing Sn (Sn-based particulate active material) in lithium secondary batteries has been proposed. (See, for example, Japanese Published Unexamined Patent Application Nos. 59-163755, 60-86759, and 1-7471.) Japanese Published Unexamined Patent Application No. 2002-75332 has proposed the use of a negative electrode, in lithium secondary batteries, having a negative electrode current collector and a sintered negative electrode mixture layer (negative electrode active material layer) that contains a binder and a particulate negative electrode active material containing Si.

In conventional lithium secondary batteries as described in JP 59-163755A, 60-86759A, and 1-7471A, which is provided with a negative electrode having a negative electrode mixture layer (negative electrode active material layer) containing a negative electrode binder and a particulate negative electrode active material containing Sn, changes in volume of the negative electrode active material layer during charge and discharge (the expansion associated with lithium intercalation during charge and the shrinkage associated with lithium deintercalation during discharge) cause pulverization of the particulate negative electrode active material due to collision between the negative electrode active material particles, destruction of the mixture layer due to destruction of the binding between the negative electrode binder and the negative electrode active material particles, and peeling-off of the negative electrode mixture layer from the negative electrode current collector due to destruction of the binding between the negative electrode current collector and the negative electrode active material particles. As a consequence, the current collection performance in the negative electrode degrades, resulting in poor charge-discharge cycle performance.

The lithium secondary battery as described in JP 2002-75332A, which is provided with a negative electrode having a negative electrode mixture layer (negative electrode active material layer) containing a binder and the particulate negative electrode active material containing Si, can inhibit the peeling-off and destruction of the negative electrode mixture layer, which are due to changes in its volume during charge and discharge, by sintering the negative electrode mixture layer. Consequently, the charge-discharge cycle performance improves. Nevertheless, because the negative electrode active material has a high content of silicon, the current collection performance in the negative electrode mixture layer lowers in the last stage of discharge when the negative electrode mixture layer shrinks, and the resistance component in the negative electrode mixture layer increases. This leads to the problem of poor discharge capacity.

In addition, when the negative electrode mixture layer contains a binder and particulate Sn, which can intercalate Li most among the Sn-based particulate active materials and has high conductivity, heat-treating to the negative electrode mixture layer leads to the following problems. Firstly, the Sn in the Sn particles reacts with a metal component (mainly copper) in the negative electrode current collector, causing degradation in the mechanical strength of the negative electrode current collector or adhering of the electrodes to each other. In addition, the amount of the Sn involved in the charge-discharge process is reduced due to the production of an intermetallic compound (Sn—Cu intermetallic compound) of Sn and the metal component.

### BRIEF SUMMARY OF THE INVENTION

Accordingly, it is an object of the present invention to provide a practical lithium secondary battery that has a greater battery capacity than in the case of using particulate graphite as the negative electrode active material but a less electrical resistance of the negative electrode mixture layer than in the case of using particulate Si as the negative electrode active material, while achieving good charge-discharge cycle performance, and to provide a method of manufacturing the battery. It is another object of the invention to provide a negative electrode for use in the lithium secondary battery according to the invention, and a method of manufacturing the electrode.

In accordance with one aspect of the present invention, the foregoing and other objects are achieved by a lithium secondary battery comprising: a negative electrode having a negative electrode current collector and a negative electrode mixture layer formed on a surface of the negative electrode current collector, the negative electrode mixture layer containing a Sn-based particulate negative electrode active material and a negative electrode binder; a positive electrode; a power-generating element comprising the negative electrode and the positive electrode; a non-aqueous electrolyte; and a battery case enclosing the power-generating element and the non-aqueous electrolyte, wherein the negative electrode binder is melt-bonded to the Sn-based particulate negative electrode active material and/or the negative electrode current collector, and the Sn-based particulate negative electrode active material comprises an intermetallic compound represented by the formula Sn_{X}M_{1-X}, where 1>X≧1/2 and M is Mn, Fe, Co, or Ni.

### BRIEF DESCRIPTION OF THE DRAWINGS

FIG. 1 is a phase diagram of an intermetallic compound of Co and Sn, for illustrating the relationship between heat treatment temperature and Sn-based particulate negative electrode active material in the mixture layer according to the present invention;

FIG. 2 is a phase diagram of an intermetallic compound of Ni and Sn, for illustrating the relationship between heat treatment temperature and Sn-based particulate negative electrode active material in the mixture layer according to the present invention;

FIG. 3 is a phase diagram of an intermetallic compound of Mn and Sn, for illustrating the relationship between heat treatment temperature and Sn-based particulate negative electrode active material in the mixture layer according to the present invention;

FIG. 4 is a phase diagram of an intermetallic compound of Fe and Sn, for illustrating the relationship between heat treatment temperature and Sn-based particulate negative electrode active material in the mixture layer according to the present invention; and

FIG. 5 is a schematic view illustrating a test cell.

### DETAILED DESCRIPTION OF THE INVENTION

The lithium secondary battery according to the present invention is furnished with a negative electrode, a positive electrode, a power-generating element comprising the negative electrode and the positive electrode, a non-aqueous electrolyte, and a battery case for enclosing the power-generating element and the non-aqueous electrolyte. The negative electrode has a negative electrode current collector and a negative electrode mixture layer formed on a surface of the negative electrode current collector. The negative electrode mixture layer contains a Sn-based particulate negative electrode active material and a negative electrode binder. The negative electrode binder is melt-bonded to the Sn-based particulate negative electrode active material and/or the negative electrode current collector, and the Sn-based particulate negative electrode active material comprises an intermetallic compound represented by the formula Sn_{X}M_{1-X}, where 1>X≧1/2 and M is Mn, Fe, Co, or Ni.

In the present specification, the term “melt-bonded” means the state of binding that is effected after substances have been deformed by undergoing thermal softening or melting. In the case that a binder and a particulate active material are melt-bonded to each other, the portion that has been melt-bonded has a smoother outer surface than in the case of mechanical deformation. The term “Sn-based particulate negative electrode active material” is intended to collectively refer to particulate negative electrode active materials that contain Sn. Specifically, the term “Sn-based particulate negative electrode active material” is meant to include particulate Sn and an intermetallic compound (alloy) of Sn and another metal.

With the above-described construction, the Sn-based particulate active material of the negative electrode mixture layer contains only the particles of an intermetallic compound represented by the formula Sn_{X}M_{1-X}, where 1>X≧0.5 and M is Mn, Fe, Co, or Ni. This allows the battery capacity to be greater than in the case of using particulate graphite as the negative electrode active material, and the electrical resistance of the negative electrode to be less than in the case of using particulate Si s as the negative electrode active material. Moreover, the charge-discharge cycle performance improves because the negative electrode binder is melt-bonded to the particulate negative electrode active material or the negative electrode current collector. Furthermore, the fact that the negative electrode mixture layer contains no particulate Sn as the Sn-based particulate active material means that it becomes possible to prevent degradation in mechanical strength of the negative electrode current collector, which is due to the reactions between the Sn in the Sn particles and a metal component in the negative electrode current collector, and to inhibit the decrease of Sn involved in the charge-discharge process, which is due to the production of a Sn—Cu intermetallic compound.

It is desirable that the negative electrode binder be heat-treated at a temperature higher than the melting point of the negative electrode binder.

This allows, when the negative electrode binder has a melting point, its temperature to exceed the melting point temporarily in the manufacturing process so that at least the surface thereof is melted. Consequently, the negative electrode binder can be melt-bonded to the Sn-based particulate active material and/or the negative electrode current collector. This improves the strength of the negative electrode mixture layer and the binding strength between the negative electrode mixture layer and the negative electrode current collector.

It is preferable that the negative electrode binder be heat-treated at a temperature higher than the glass transition temperature of the negative electrode binder.

This allows, when the negative electrode binder has a glass transition temperature, its temperature to exceed the glass transition temperature temporarily in the manufacturing process so that at least the surface thereof is softened. Consequently, the negative electrode binder can be melt-bonded to the Sn-based particulate active material and/or the negative electrode current collector. This improves the strength of the negative electrode mixture layer and the binding strength between the negative electrode mixture layer and the negative electrode current collector.

It is desirable that the negative electrode binder be PVdF.

This makes it possible to improve the strength of the negative electrode binder itself, accordingly improving the strength of the negative electrode mixture layer.

It is desirable that the Sn-based particulate negative electrode active material be made of an intermetallic compound represented as Co_{1-Y}Sn_{Y}, where 2/3≧Y≧1/2.

This construction attains high battery capacity and high electric conductivity in the negative electrode. This achieves long life and high current.

It is desirable that the negative electrode current collector be made of an alloy foil containing 90 mass % or more of copper.

With this construction, the negative electrode current collector is allowed to have high electric conductivity, and therefore, a negative electrode is achieved that has good current collection performance and higher strength than that made of a pure copper foil. That said, it is possible to use a pure copper foil as the negative electrode current collector in the present invention. The alloy containing 90 mass % or more of copper may be made of copper and other substance(s) such as Zr (zirconium) and Mg (magnesium). Specific examples of the alloy material containing 90 mass % or more of copper are shown in Table 1 below.

TABLE 1
(Percentage: wt. %)

| Alloy | Composition |
|---|---|
| Tin-containing | Copper with 0.05-0.2% tin and 0.04% or |
| copper | less phosphorus added |
| Silver-containing | Copper with 0.08-0.25% silver added |
| copper | |
| Zirconium copper | Copper with 0.02-0.2% zirconium added |
| Chromium copper | Copper with 0.4-1.2% chromium added |
| Titanium copper | Copper with 1.0-4.0% titanium added |
| Beryllium copper | Copper with 0.4-2.2% beryllium and trace |
| | amounts of cobalt, nickel, and iron added |
| Iron-containing | Copper with 0.1-2.6% iron and 0.01-0.3% |
| copper | phosphorus added |
| Tin-containing | 80.0-95.0% copper, 1.5-3.5% tin, and |
| brass | the rest being zinc |
| Phosphor bronze | Copper being the main component, containing |
| | 3.5-9.0% tin, and 0.03-0.35% phosphorus |
| Aluminum bronze | 77.0-92.5% copper, 6.0-12.0% aluminum, |
| | 1.5-6.0% iron, 7.0% or less nickel, and |
| | 2.0% or less manganese |
| Cupro-nickel | Copper being the main component, containing |
| | 9.0-33.0% nickel, 0.40-2.3% iron, |
| | 0.20-2.5% manganese, and 1.0% or less zinc |
| Corson alloy | Copper containing 3% nickel, 0.65% silicon, |
| | and 0.15% magnesium |
| Cr—Zr copper | Copper containing 0.2% chromium, 0.1% |
| alloy | zirconium, and 0.2% zinc |

It is desirable that the negative electrode current collector have a surface roughness Ra of 0.2 μm or greater.

This construction makes it possible to increase the contact area between the negative electrode current collector and the negative electrode binder and therefore can minimize the peeling-off of the negative electrode mixture layer from the negative electrode current collector.

In accordance with another aspect of the present invention, the foregoing and other objects are achieved by a negative electrode for a lithium secondary battery, comprising: a negative electrode current collector; and a negative electrode mixture layer formed on a surface of the negative electrode current collector, the negative electrode mixture layer containing a Sn-based particulate negative electrode active material and a negative electrode binder, wherein: the negative electrode binder is melt-bonded to the Sn-based particulate negative electrode active material and/or the negative electrode current collector; and the Sn-based particulate negative electrode active material is made of an intermetallic compound represented as Sn_{X}M_{1-X}, where 1>X≧1/2 and M is Mn, Fe, Co, or Ni.

This construction makes it possible to form a negative electrode that has high electric conductivity and lithium intercalation capability as well as good resistance against the peeling-off of the mixture layer from the current collector.

In accordance with yet another aspect of the present invention, the foregoing and other objects are achieved by a method of manufacturing a lithium battery, including: forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni to a surface of a negative electrode current collector, drying the negative electrode mixture slurry with the current collector and pressure-rolling the negative electrode mixture with the current collector; heating the negative electrode mixture layer at a process temperature higher than the melting point of the negative electrode binder to prepare a negative electrode; heating the negative electrode mixture layer at a process temperature higher than the melting point of the negative electrode binder to prepare a negative electrode; preparing an electrode assembly comprising the negative electrode and the positive electrode; and thereafter enclosing the electrode assembly and a non-aqueous electrolyte in a battery case.

The above-described method makes it possible to melt-bond the negative electrode binder to the Sn-based particulate negative electrode active material and/or the negative electrode current collector by heating the negative electrode binder having a melting point to a temperature higher than the melting point, and thus to manufacture the above-described lithium secondary battery in a simple and reliable manner.

In accordance with still another aspect of the present invention, the foregoing and other objects are achieved by a method of manufacturing a lithium battery, including: forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni to a surface of a negative electrode current collector, drying the negative electrode mixture slurry with the current collector and pressure-rolling the negative electrode mixture with the current collector; heating the negative electrode mixture layer at a process temperature higher than the glass transition temperature of the negative electrode binder to prepare a negative electrode; preparing an electrode assembly comprising the negative electrode and the positive electrode; and thereafter enclosing the electrode assembly and a non-aqueous electrolyte in a battery case.

The above-described method makes it possible to melt-bond the negative electrode binder to the Sn-based particulate negative electrode active material and/or the negative electrode current collector by heating the negative electrode binder having a glass transition temperature to a temperature higher than the glass transition temperature, and thus to manufacture the above-described lithium secondary battery in a simple and reliable manner.

It is desirable that the process temperature be lower than the melting point of the intermetallic compound and the melting point of the negative electrode current collector.

This makes it possible to prevent the intermetallic compound that constitutes the Sn-based particulate negative electrode active material and the negative electrode current collector from being melted and thus inhibit them from being deformed in shape or changed in composition.

It is desirable that the process temperature be lower than the eutectic point of the intermetallic compound.

This makes it possible to prevent the intermetallic compound that constitutes the Sn-based particulate negative electrode active material from being changed in composition.

In accordance with still another aspect of the present invention, the foregoing and other objects are achieved by providing a method of manufacturing a negative electrode for a lithium secondary battery, including: forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni, to a surface of a negative electrode current collector, drying the negative electrode mixture slurry with the current collector and pressure-rolling the negative electrode mixture with the current collector; and heating the negative electrode mixture layer at a process temperature higher than the melting point of the negative electrode binder.

The above-described method makes it possible to melt-bond the negative electrode binder to the Sn-based particulate negative electrode active material and/or the negative electrode current collector by heating the negative electrode binder having a melting point to a temperature higher than the melting point, and thus to manufacture the above-described negative electrode for a lithium secondary battery in a simple and reliable manner.

In accordance with further another aspect of the present invention, the foregoing and other objects are achieved by providing a method of manufacturing a negative electrode for a lithium secondary battery, including: forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni, to a surface of a negative electrode current collector, drying the negative electrode mixture slurry with the current collector and pressure-rolling the negative electrode mixture with the current collector; and heating the negative electrode mixture layer at a process temperature higher than the glass transition temperature of the negative electrode binder.

The above-described method makes it possible to melt-bond the negative electrode binder to the Sn-based particulate negative electrode active material and/or the negative electrode current collector by heating the negative electrode binder having a glass transition temperature to a temperature higher than the glass transition temperature, and thus to manufacture the above-described negative electrode for a lithium secondary battery in a simple and reliable manner.

As described above, with the lithium secondary battery according to the present invention, the Sn-based particulate active material of the negative electrode mixture layer contains only the particles of an intermetallic compound represented by the formula Sn_{X}M_{1-X}, where 1>X≧0.5 and M is Mn, Fe, Co, or Ni. This allows the battery capacity to be greater than in the case of using particulate graphite as the negative electrode active material, and the electrical resistance of the negative electrode to be less than in the case of using particulate Si as the negative electrode active material. Moreover, the charge-discharge cycle performance improves because the negative electrode binder is melt-bonded to the particulate negative electrode active material or the negative electrode current collector. Furthermore, the fact that the negative electrode mixture layer contains no particulate Sn as the Sn-based particulate means that it becomes possible to prevent degradation in mechanical strength of the negative electrode current collector, which is due to the reactions between the Sn in the Sn particles and a metal component in the negative electrode current collector, and to inhibit the decrease of Sn involved in the charge-discharge process, which originates from a decrease in surface area of the active material due to aggregation of Sn particles.

The foregoing manufacturing methods makes it possible to melt-bond the negative electrode binder to the Sn-based particulate negative electrode active material and/or the negative electrode current collector by heating the negative electrode binder to a temperature higher than the melting point or glass transition temperature thereof, and thus to manufacture the above-described negative electrode for a lithium secondary battery as described above in a simple and reliable manner.

Moreover, the negative electrode for a lithium secondary battery according to the present invention has high electric conductivity and high lithium intercalation capability, and it shows good resistance against the peeling-off of the negative electrode mixture layer from the current collector. Furthermore, using the electrode according to the present invention as the negative electrode of a lithium secondary battery makes it possible to achieve the lithium secondary battery that exhibits the performance as described above.

The methods of manufacturing negative electrodes for lithium secondary batteries according to the present invention make it possible to melt-bond the negative electrode binder to the Sn-based particulate negative electrode active material and/or the negative electrode current collector by heating the binder to a temperature higher than the melting point or glass transition temperature thereof, and thus to manufacture the negative electrode provided with the above-described characteristics in a simple and reliable manner.

Hereinbelow, the present invention is described in further detail based on preferred embodiments thereof. It should be construed, however, that the present invention is not limited to the following preferred embodiments but various changes and modifications are possible without departing from the scope of the invention.

### EXAMPLE 1

Preparation of Negative Electrode

A particulate negative electrode active material containing the CoSn phase and the CoSn₂ phase at a molar ratio of 1:1 (average particle size: 10 μm) were mixed into an N-methyl-2-pyrrolidone solution in which PVdF was dissolved at 8 mass %, to thus prepare a negative electrode mixture slurry. The solid mass ratio of the particulate negative electrode active material to the PVdF in the negative electrode mixture slurry was adjusted to be 93:7 (solid volume ratio: 75:25).

The resultant negative electrode mixture slurry was applied onto one side (the roughened surface side) of an electrolytic copper foil (thickness: 35 μm) having a surface roughness Ra of 1.0 μm and serving as a negative electrode current collector, and thereafter the negative electrode mixture slurry was dried. The resultant layered material was cut out into dimensions of 20 mm×20 mm and then pressure-rolled. Thereafter, the resultant material was heated (heat-treated) under an argon atmosphere at a process temperature of 400° C. for 1 hour, to thus form a negative electrode mixture layer (thickness: 6 μm).

Preparation of Positive Electrode

A 0.34 mm-thick lithium metal sheet was cut out into dimensions of 30 mm×30 mm to thus prepare a positive electrode.

Preparation of Electrolyte Solution

LiPF₆ was dissolved at a concentration of 1 mol/L into a mixed solvent of 3:7 volume ratio of ethylene carbonate and diethylene carbonate. An electrolyte solution was thus prepared.

Preparation of Test Cell (Battery)

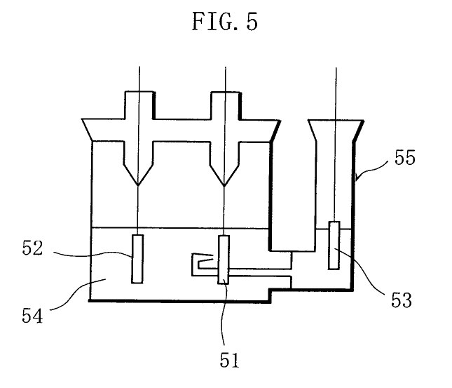

A test cell as shown in FIG. 5 was prepared in which a working electrode 51 (the negative electrode) and a counter electrode 52 (the positive electrode) made of metallic lithium were immersed in a non-aqueous electrolyte solution 54 filled in a three-electrode glass beaker cell 55 (corresponding to the battery case). Referring to FIG. 5, the test cell is provided with a reference electrode 53 made of metallic lithium. It should be noted that such test cells were also used as the batteries for performance evaluation throughout the later-described Example 2 and Comparative Examples 1 to 7.

The negative electrode and the battery prepared in the foregoing manner are hereinafter referred to as a negative electrode a1 of the invention and Battery A1 of the invention. It should be noted that an actual battery may be fabricated in the following manner, for example. An electrode assembly is prepared with the positive electrode, the negative electrode, and a microporous polyethylene separator, which is interposed between the positive electrode and the negative electrode. The electrode assembly is placed into a battery case made of an aluminum laminate, and the non-aqueous electrolyte prepared in the above-described manner is also filled into the battery case under an argon atmosphere at room temperature and at atmospheric pressure.

### EXAMPLE2

A negative electrode and a battery were fabricated in the same manner as in Example 1 above, except that powder (average particle size: 10 μm) composed only of the Co₂—Sn phase was used as the particulate negative electrode active material.

The negative electrode and the battery thus prepared are hereinafter referred to as a negative electrode a2 of the invention and Battery A2 of the invention.

### COMPARATIVE EXAMPLE 1

A negative electrode and a battery were fabricated in the same manner as in Example 1 above, except that Sn powder (average particle size: 10 μm) was used as the particulate negative electrode active material.

The negative electrode and the battery thus prepared are hereinafter referred to as a comparative negative electrode z1 and Comparative Battery Z1, respectively.

### COMPARATIVE EXAMPLE 2

A negative electrode and a battery were fabricated in the same manner as in Example 1 above, except that Si powder (average particle size: 5 μm) was used as the particulate negative electrode active material and that the solid mass ratio of the Si powder to the PVdF was adjusted to be 80:20. The solid mass ratio of the Si powder to the PVdF was varied in this way in order to adjust the solid volume ratio of the Si powder to the PVdF to be the same 75:25 as in Example 1.

The negative electrode and the battery thus prepared are hereinafter referred to as a comparative negative electrode z2 and Comparative Battery Z2, respectively.

### COMPARATIVE EXAMPLES 3 to 6

Negative electrodes and batteries were fabricated in the same manner as in Examples 1 and 2 and Comparative Examples 1 and 2 above, except that no heat treatment was carried out for their negative electrode binder.

The negative electrodes and the batteries thus prepared are hereinafter referred to as comparative negative electrodes z3 to z6 and Comparative Batteries Z3 to Z6, respectively.

### COMPARATIVE EXAMPLE 7

A negative electrode and a battery were fabricated in the same manner as in Example 1 above, except that graphite powder (average particle size: 20 μm) was used as the particulate negative electrode active material, that no heat treatment was carried out for the negative electrode binder, and that the solid mass ratio of the graphite powder to the PVdF was adjusted to be 90:10.

The negative electrode and the battery thus prepared are hereinafter referred to as a comparative negative electrode z7 and Comparative Battery Z7, respectively.

### Experiment 1

A charge-discharge test was conducted under the charge-discharge test conditions set out below, to determine initial charge capacity per unit mass of negative electrode active material (hereafter also simply referred to as “initial charge capacity”) and discharge capacity retention ratio after 5 cycles (hereafter also simply referred to as “discharge capacity retention ratio”) for the foregoing batteries. The results are shown in Table 2 below. It should be noted that the discharge capacity retention ratio after 5 cycles means the ratio of discharge capacity after 5 cycles to initial discharge capacity as defined by the following equation (1).
Discharge capacity retention ratio after 5 cycles=Discharge capacity after 5 cycles/Initial discharge capacity×100 Eq. (1)
Charge-discharge Test Conditions

Conditions of charge (lithium insertion to negative electrode)

The batteries were charged at a constant current of 0.1 mA/cm² to an end-of-charge voltage of 0.0 V (vs. Li/Li⁺).

Conditions of discharge (lithium deinsertion from negative electrode)

The batteries were discharged at a constant current of 0.1 mA/cm² to an end-of-discharge voltage of 2.0 V (vs. Li/Li⁺).

TABLE 2

| | | | | | Capacity |
|---|---|---|---|---|---|
| | | | Heat- | Initial | retention |
| | Negative | Active | treat- | charge | ratio after |
| Battery | electrode | material | ment | capacity | 5 cycles |
| A1 | a1 | CoSn₂ + | Yes | 503 mAh/g | 104% |
| | | CoSn | | | |
| A2 | a2 | CoSn₂ | Yes | 626 mAh/g | 94% |
| Z1 | z1 | Sn | Yes | Non- | Non- |
| | | | | measurable | measurable |
| Z2 | z2 | Si | Yes | 4000 mAh/g | 92% |
| Z3 | z3 | CoSn₂ + | No | 540 mAh/g | 28% |
| | | CoSn | | | |
| Z4 | z4 | CoSn₂ | No | 651 mAh/g | 24% |
| Z5 | z5 | Sn | No | 821 mAh/g | 6% |
| Z6 | z6 | Si | No | 3950 mAh/g | 2% |
| Z7 | z7 | C | No | 370 mAh/g | 100% |

As seen from Table 2, Comparative Batteries Z3 and Z4 showed comparable initial charge capacities but lower discharge capacity retention ratios than Batteries A1 and A2 of the invention. It should be noted that Comparative Batteries Z3 and Z4 employed particulate negative electrode active materials made of intermetallic compounds represented as Sn_{X}M_{1-X} (where 1>X≧0.5 and M is Co) but did not undergo the heat treatment, while Batteries A1 and A2 of the invention employed particulate negative electrode active materials made of intermetallic compounds represented as Sn_{X}M_{1-X} (where 1>X≧0.5 and M is Co) and underwent the heat treatment.

It was also observed that Comparative Batteries Z5 and Z6 showed higher initial charge capacities but extremely lower discharge capacity retention ratios than Batteries A1 and A2 of the invention. It should be noted that Comparative Battery Z5 used a particulate negative electrode active material made of Sn and did not undergo the heat treatment, and Comparative Battery Z6 used a particulate negative electrode active material made of Si and did not undergo the heat treatment.

Further, it was observed that Comparative Battery Z7 showed a discharge capacity retention ratio comparable to Batteries A1 and A2 of the invention but an initial charge capacity lower than Batteries A1 and A2 of the invention. It should be noted that Comparative Battery Z7 used a particulate negative electrode active material made of graphite and did not undergo the heat treatment. This demonstrates that the batteries according to the present invention are capable of greater initial charge capacities than the batteries that use negative electrode active materials made of graphite, which are currently in commercial use.

In addition, the characteristics of Comparative Battery Z1 were unable to be evaluated because the electrodes adhered to each other. It should be noted that Comparative Battery Z1 used a particulate negative electrode active material made of Sn and underwent the heat treatment. In contrast, Batteries A1 and A2 of the invention were free from such a problem. This demonstrates that the problem in the fabrication, that is, the adhering of the electrodes to each other in the heat treatment, will not arise in the batteries according to the invention.

It was observed that Comparative Battery Z2 showed a higher initial charge capacity than Batteries A1 and A2 of the invention, and moreover achieved a reasonable level of discharge capacity retention ratio. Note that Comparative Battery Z2 used a particulate negative electrode active material made of Si and underwent the heat treatment. Nevertheless, as will be demonstrated in Experiment 2 below, Comparative Battery Z2 (comparative negative electrode z2) has the problem of very poor high rate discharge capability.

The eutectic point of CoSn is 936° C., the eutectic point of CoSn₂ is 525° C., and the glass transition temperature of PVdF is 170° C. The melting point of copper, which is used as the material for the electrolytic copper foil serving as the negative electrode current collector, is 1083° C. This means that the adhesion between the negative electrode and the negative electrode mixture layer is enhanced by carrying out the heat treatment at a process temperature in the range of from 170° C. to 525° C., for example, at 400° C. as employed in the foregoing examples.

### Experiment 2

The plate resistances were measured for the negative electrodes a1 and a2 of the invention, as well as the comparative negative electrodes z2 to z7. The results are shown in Table 3. For the measurement, a resistivity meter [Loresta-GP (MCP-T600) made by Dia Instrument Co., Ltd.] was used. The probe was pressed against each of the negative electrode surface, and the value obtained was adopted as its plate resistance.

TABLE 3

| Negative | | | | |
|---|---|---|---|---|
| electrode | Active material | Heat-treatment | Plate resistance | |
| a1 | CoSn₂ + CoSn | Yes | 0.21 | Ω |
| a2 | CoSn₂ | Yes | 0.22 | Ω |
| z2 | Si | Yes | 2.4 × 10⁴ | Ω |
| z3 | CoSn₂ + CoSn | No | 0.20 | Ω |
| z4 | CoSn₂ | No | 0.23 | Ω |
| z5 | Sn | No | 5 | Ω |
| z6 | Si | No | 2.0 × 10⁴ | Ω |
| z7 | C | No | 0.57 | Ω |

As seen from Table 3 above, it was observed that the negative electrodes a1 and a2 of the invention showed plate resistances of about 1/1000 to 1/10000 of those of the comparative negative electrodes z2 and z6. It should be noted that the negative electrodes a1 and a2 of the invention employed a particulate negative electrode active material made of an intermetallic compound represented as Sn_{X}M_{1-X}, where 1>X≧0.5 and M is Co, while the comparative negative electrodes z2 and z6 employed a particulate negative electrode active material made of Si. It is believed that this is due to the fact that the just-mentioned intermetallic compound used as the negative electrode active material of the negative electrodes a1 and a2 of the invention has higher electron conductivity than Si, which is used as the negative electrode active material of the comparative negative electrodes z2 and z6.

If the plate resistance is high as with the comparative negative electrodes z2 and z6, the overvoltage that is generated in the negative electrode during charge and discharge of the battery will be great. The overvoltage is proportional to the magnitude of the current during discharge of the battery, so if the plate resistance is high, the lithium that should otherwise be released electrochemically from the negative electrode active material cannot be released correspondingly to the magnitude of the overvoltage, and consequently the battery capacity is reduced. For these reasons, the use of Si as the negative electrode active material incurs degradation in high rate discharge capability.

As has been demonstrated above, it will be appreciated that by using only the particulate negative electrode active material made of an intermetallic compound represented as Sn_{X}M_{1-X}, where 1>X≧0.5 and M is Co, a negative electrode with low plate resistance can be achieved, and as a result, the high rate discharge capability of the battery that uses the just-mentioned negative electrode can be improved.

The plate resistances of the comparative negative electrodes z3 to z5 and z7 were approximately the same as those of the negative electrodes a1 and a2 of the invention, or slightly higher.

### Experiment 3

Samples of Batteries A1 and A2 of the invention, as well as Comparative Batteries Z2 to Z6 were disassembled in their charged state and in their discharged state, and the thicknesses of the negative electrode mixture layers were measured, to determine the expansion ratio defined by the following equation (2). The results are shown in Table 4 below. The thickness of each of the negative electrode mixture layers was calculated by subtracting the thickness of the negative electrode current collector (35 μm) from the total thickness of the negative electrode as measured with a micrometer. In addition, Table 4 also shows the thicknesses of the negative electrode active material layers after the 5th cycle discharge for reference.
Expansion ratio=Thickness of the negative electrode active material layer after 6 cycles of charging/Thickness of the negative electrode active material layer before charging Eq. (2)

TABLE 4

| | | | | | Thickness of active | Thickness of active | |
|---|---|---|---|---|---|---|---|
| | | | | Thickness of active | material layer after | material layer after | |
| | Negative | Active | Heat | material layer before | discharge at the 5th | charge at the 6th | Expansion |
| Battery | electrode | material | treatment | charge and discharge | cycle | cycle | ratio |
| A1 | a1 | CoSn₂ + | Yes | 6 μm | 16 μm | 28 μm | 4.67 |
| | | CoSn | | | | | |
| A2 | a2 | CoSn₂ | Yes | 6 μm | 26 μm | 28 μm | 4.67 |
| Z2 | z2 | Si | Yes | 4 μm | 18 μm | 20 μm | 5.00 |
| Z3 | z3 | CoSn₂ + | No | 6 μm | 26 μm | 34 μm | 5.67 |
| | | CoSn | | | | | |
| Z4 | z4 | CoSn₂ | No | 6 μm | 39 μm | 47 μm | 7.83 |
| Z5 | z5 | Si | No | 8 μm | 53 μm | 58 μm | 7.25 |
| Z6 | z6 | C | No | 4 μm | 16 μm | 30 μm | 7.50 |

As clearly seen from Table 4, all the comparative negative electrodes z2 to z6 showed electrode plate expansion ratios of 5.0 or greater, whereas the negative electrodes a1 and a2 of the invention exhibited electrode plate expansion ratio of less than 5.0. Thus, it is believed due to the fact the negative electrodes a1 and a2 of the invention were capable of lessening the expansion of the negative electrode active material layer that they exhibited good charge-discharge cycle performance as shown in the foregoing Experiment 1. The reason why the negative electrodes a1 and a2 of the invention were capable of lessening the expansion of the negative electrode active material layer is that performing the heat treatment served to increase the binding strength within the negative electrode active material layer.

### Other Embodiments

(1) Variations of the Negative Electrode

(a) The foregoing examples have described the cases in which the Sn-based negative active material is composed only of the particulate active material made of an intermetallic compound represented as Sn_{X}M_{1-X}, where 1>X≧0.5 and M is Co. However, we have confirmed that the same effects are attained also when the Sn-based negative active material is composed only of the particulate active material made of an intermetallic compound represented as Sn_{X}M_{1-X}, where 1>X≧0.5 and M is Mn, Fe, or Ni. It is also possible that the negative electrode mixture layer may contain a plurality of kinds of Sn-based particulate active material as long as they are particulate active materials made of intermetallic compounds represented as Sn_{X}M_{1-X}, where 1>X≧1/2 and M is Mn, Fe, Co, or Ni. Moreover, the negative electrode mixture layer may further contain a particulate active material made of a different substance from the Sn-based particulate negative electrode active material.

(b) It is preferable that the negative electrode binder have either a glass transition temperature (Tg) or a melting point (Tm). The reason is that the use of such a binder serves to improve the binding of the negative electrode binder with the negative electrode active material particles or with the negative electrode current collector through the heat treatment, and consequently, their adhesion improves because of the resulting increase in the contact area.

(c) Preferable examples of the negative electrode binder include PVdF (polyvinylidene fluoride), PTFE (polytetrafluoroethylene), PFA (perfluoroalkoxy alkane), and polyimide resins. These materials have high mechanical strength and good elasticity. Accordingly, even when changes in volume of the mixture layer occur during the lithium intercalation and deintercalation, the negative electrode binder itself will not fracture. Thus, the deformation of the negative electrode mixture layer associated with the changes in volume of the negative electrode mixture layer can be minimized, the current collection performance in the negative electrode maintained, and outstanding cycle performance attained.

(d) It is preferable that the amount of the negative electrode binder be 1 mass % or more of the total weight of the mixture layer, and the volume of the negative electrode binder be 5% or more of the total volume of the mixture layer. If the amount of the negative electrode binder is less than 1 mass % of the total weight of the mixture layer or if the volume of the negative electrode binder is less than 5% of the total volume of the mixture layer, adhesion within the negative electrode provided by the negative electrode binder will be insufficient because the amount of the negative electrode binder is too small relative to the amount of the particulate negative electrode active material. On the other hand, if the amount of the negative electrode binder is too large, resistance in the negative electrode will increase, making it difficult to perform the initial charging. Therefore, it is preferable that the amount of negative electrode binder be 20 mass % or less of the total weight of the negative electrode mixture layer and the volume of the negative electrode binder be 20% or less of the total volume of the mixture layer.

(e) The average particle size of the negative electrode active material particles is not particularly limited, but should preferably be one half or less of the thickness of the mixture layer formed. For example, when the mixture layer is formed to have a thickness of about 60 μm, it is preferable that the average particle size be 30 μm.

(f) It is preferable that the surface of the conductive metal foil serving as the negative electrode current collector on which the negative electrode mixture layer is disposed have a surface roughness Ra of 0.2 μm or greater. The use of a conductive metal foil having such a surface roughness Ra as the negative electrode current collector allows the negative electrode binder to get into the portions of the current collector surface in which the surface irregularities exist, exerting an anchoring effect and thereby providing tight binding between the negative electrode binder and the negative electrode current collector. As a result, peeling-off of the negative electrode mixture layer from the negative electrode current collector due to the expansion and shrinkage in volume of the particulate active material, which are associated with the lithium intercalation and deintercalation, is minimized. It should be noted that when the negative electrode mixture layer is provided on both surfaces of the negative electrode current collector, it is preferable that both surfaces of the negative electrode current collector have a surface roughness Ra of 0.2 μm or greater.

It is preferable that the just-mentioned surface roughness Ra and mean spacing of local peaks S have a relationship 100 Ra≧S. Surface roughness Ra and mean spacing of local peaks S are defined in Japanese Industrial Standards (JIS B 0601-1994) and can be measured by, for example, a surface roughness meter.

To provide the surface of the negative current collector with a surface roughness Ra of 0.2 μm or greater, the negative current collector may be subjected to a roughening process. Examples of such a roughening process include plating, vapor deposition, etching, and polishing. Plating and vapor deposition are techniques in which a surface of a metal foil is roughened by forming a thin film layer with irregularities on the metal foil surface. Examples of the plating include electroplating and electroless plating. Examples of the vapor deposition include sputtering, chemical vapor deposition, and evaporation. In addition, examples of the etching include such techniques as physical etching and chemical etching. Examples of the polishing include polishing with sandpaper and polishing by blasting.

(g) Although there is no particular restriction on the thickness of the conductive metal foil, serving as the negative electrode current collector, it is preferable that it be within the range of from 5 μm to 30 μm. If the conductive metal foil is too thin, defects such as cuts in the foil occur in the fabrication process of the electrode. On the other hand, if the conductive metal foil is too thick, the advantage over the negative electrode using graphite as negative electrode active material will be lessened.

(h) In the negative electrode for the lithium secondary battery of the present invention, conductive particles may be mixed in the mixture layer. By adding conductive particles, a conductive network forms around the negative electrode active material particles, thereby further improving the current collection performance in the negative electrode. Conductive particles made of the same material as that of the conductive metal foil may be suitably used.

Specific examples include metals such as copper, nickel, iron, titanium, and cobalt, as well as alloys thereof and mixtures thereof. In particular, particulate copper is preferably used as the particulate metal. In addition, particulate conductive carbon is also preferably used. In the case of using particulate conductive carbon, the particulate carbon can also function as a negative electrode active material.

It is preferable that the amount of added conductive particles be 10 mass % or less of the total weight of the conductive particles and the raw materials for the active material. If the amount of the added conductive powder is too large, the charge-discharge capacity of the negative electrode will be too small because the mass ratio of the active material becomes relatively less. Although there is no restriction on the average particle size of the conductive particles, it is preferable that it be 50 μm or less, and more preferably 10 μm or less.

(i) It is preferable that the heat treatment to the negative electrode for the lithium secondary battery of the present invention be carried out under an inert gas atmosphere, such as vacuum, a nitrogen atmosphere, or an argon atmosphere. The heat treatment may be conducted under a reducing atmosphere such as a hydrogen atmosphere. It is preferable that the process temperature in the heat treatment be a temperature higher than the melting point or glass transition temperature of the binder. In addition, it is preferable that the process temperature in the heat treatment be the lowest temperature of the melting point and eutectic point of the particulate active material and the melting point of the current collector material.

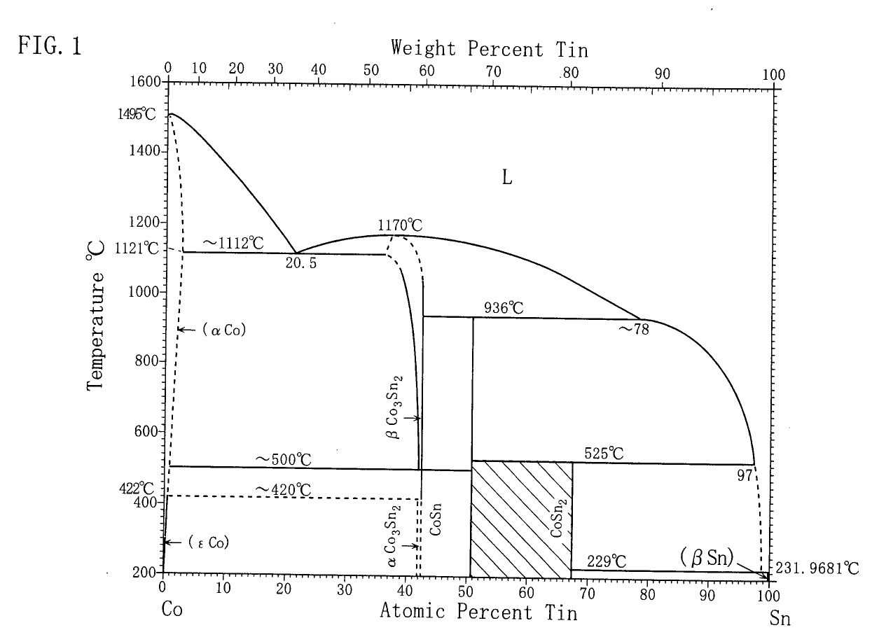

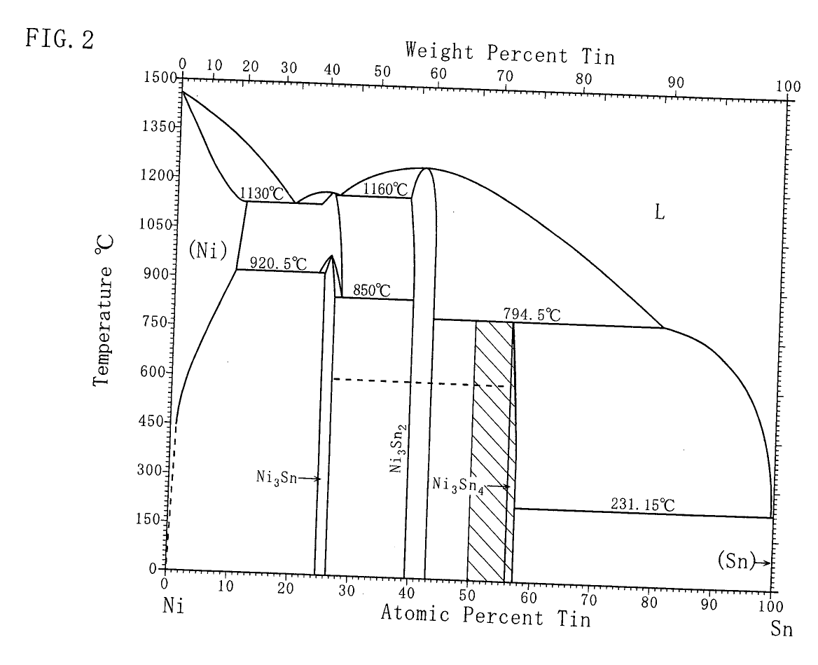

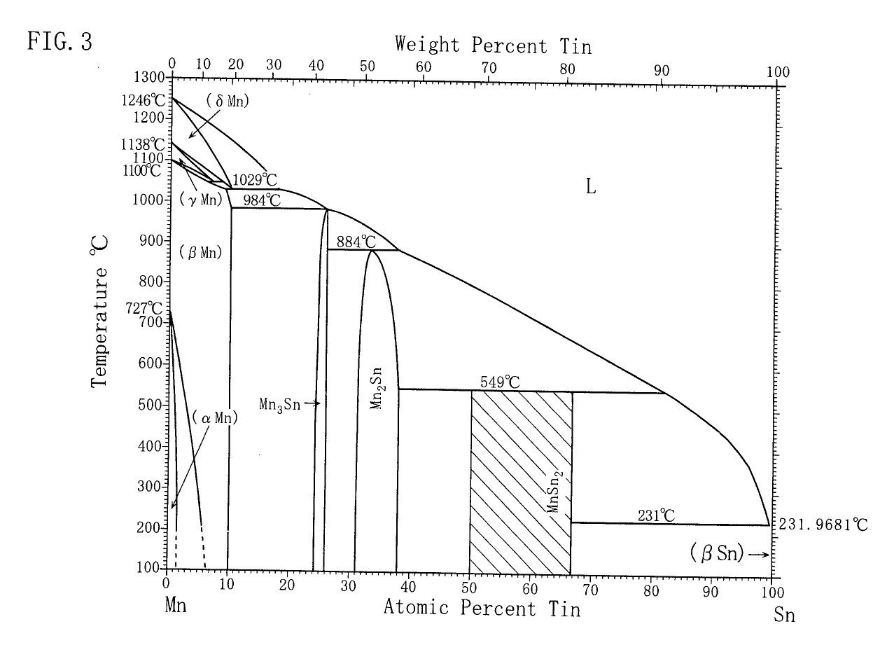

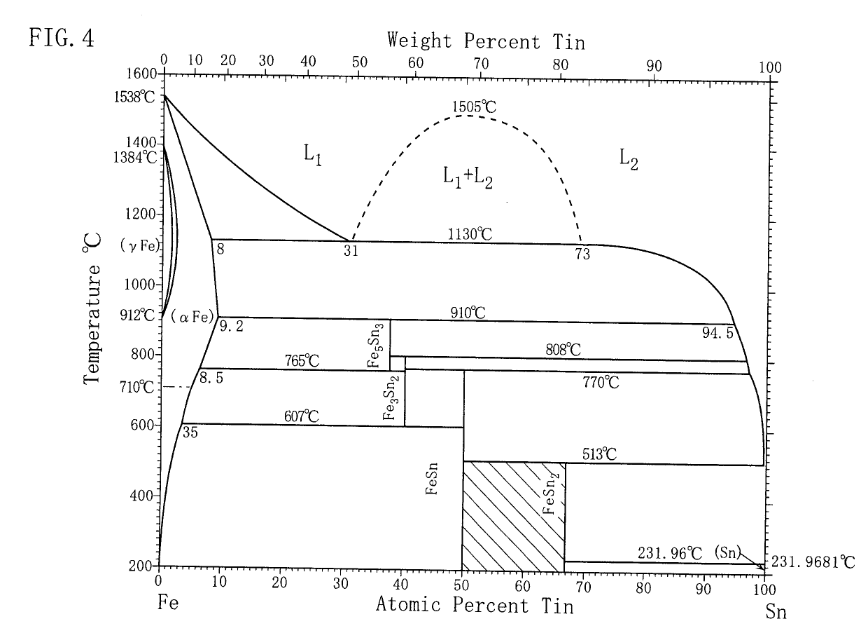

Here, suitable materials for the particulate active material and suitable process temperatures for the materials will be discussed below. FIG. 1 is a phase diagram of Co—Sn intermetallic compound, FIG. 2 is a phase diagram of Ni—Sn intermetallic compound, FIG. 3 is a phase diagram of Mn—Sn intermetallic compound, and FIG. 4 is a phase diagram of Fe—Sn intermetallic compound. As seen from FIG. 1, when the Sn-based active material particle is a Co—Sn intermetallic compound particle, it is preferable to heat-treat a compound that corresponds to an arbitrary point in the hatched region of in FIG. 1 at a process temperature that corresponds to that arbitrary point. For example, when using a pure copper foil (melting point: 1083° C.) the current collector, CoSn₂ (eutectic point 525° C.) as the active material, and PVdF (melting point: 170° C.) as the negative electrode binder, it is preferable that the heat treatment be conducted at a temperature in the range of from 170° C. to 525° C.

Likewise, when the Sn-based active material particle is a Ni—Sn intermetallic compound particle, it is preferable to heat-treat a compound that corresponds to an arbitrary point in the hatched region of in FIG. 2 at a process temperature that corresponds to that arbitrary point. Specifically, it is preferable to use an intermetallic compound that is between Ni₃Sn₂ and Ni₃Sn₄ and has a Ni content of 50 at % or more, and to conduct the heat treatment at a process temperature of 794.5° C. or lower. It should be noted that the lower limit of the process temperature is determined depending on the kind of the negative electrode binder.

Likewise, when the Sn-based active material particle is a Mn—Sn intermetallic compound particle, it is preferable to heat-treat a compound that corresponds to an arbitrary point in the hatched region of in FIG. 3 at a process temperature that corresponds to that arbitrary point. Specifically, it is preferable to use an intermetallic compound that is between Mn₂Sn and MnSn₂ and has a Mn content of 50 at % or more, and to conduct the heat treatment at a process temperature of 549° C. or lower. It should be noted that the lower limit of the process temperature is determined depending on the kind of the negative electrode binder.

Likewise, when the Sn-based active material particle is a Fe—Sn intermetallic compound particle, it is preferable to heat-treat a compound that corresponds to an arbitrary point in the hatched region of in FIG. 4 at a process temperature that corresponds to that arbitrary point. Specifically, it is preferable to use an intermetallic compound that is between FeSn and FeSn₂ and to conduct the heat treatment at a process temperature of 513° C. or lower. It should be noted that the lower limit of the process temperature is determined depending on the kind of the negative electrode binder.

j) In the negative electrode for the lithium secondary battery according to the present invention, it is preferable that, after the negative electrode mixture layer has been formed on the conductive metal foil serving as the negative electrode current collector, the negative electrode mixture layer be pressure-rolled together with the conductive metal foil before the heat treatment is performed. The pressure-rolling can increase the filling density in the negative electrode mixture layer and can enhance adhesion between the negative electrode active material particles and adhesion between the negative electrode active material particles and the negative electrode current collector, thus achieving more desirable charge-discharge cycle performance.

(2) Variations of the Non-aqueous Electrolyte

(a) Examples of the solvent of the non-aqueous electrolyte used in the present invention include, but are not particularly limited to, cyclic carbonates such as ethylene carbonate, propylene carbonate, butylene carbonate, and vinylene carbonate; and chain carbonates such as dimethyl carbonate, ethyl methyl carbonate, and diethyl carbonate. Cyclic carbonates are preferable. Examples also include mixed solvents in which any of the just-mentioned solvents is mixed with an ether-based solvent such as 1,2-dimethoxyethane and 1,2-diethoxyethane or with a chain ester such as γ-butyrolactone, sulfolane, and methyl acetate.

(b) Examples of the solute of the non-aqueous electrolyte include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures thereof.

(3) Variations of the Positive Electrode

Examples of the positive electrode active material for the lithium secondary battery of the present invention include lithium-containing transition metal oxides, such as LiCoO₂, LiNiO₂, LiMn₂O₄, LiMnO₂, LiCo_{0.5}Ni_{0.5}O₂, and LiNiₓCo_{y}Mn_{z}O₂, as well as metal oxides that do not contain lithium, such as MnO₂. In addition, various substances may be used without limitation as long as such substances are capable of electrochemically intercalating and deintercalating lithium.

The invention is applicable not only to driving power sources for mobile information terminals such as mobile telephones, notebook computers and PDAs but also to large-sized batteries for, for example, in-vehicle power sources for electric automobiles or hybrid automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A lithium secondary battery comprising:
a negative electrode having a negative electrode current collector and a negative electrode mixture layer formed on a surface of the negative electrode current collector, the negative electrode mixture layer containing a Sn-based particulate negative electrode active material and a negative electrode binder;
a positive electrode;
a power-generating element comprising the negative electrode and the positive electrode;
a non-aqueous electrolyte; and
a battery case enclosing the power-generating element and the non-aqueous electrolyte,
wherein:
the negative electrode binder is melt-bonded to the Sn-based particulate negative electrode active material and/or the negative electrode current collector, and Sn-based particulate negative electrode active material comprises an intermetallic compound represented by the formula Sn_{X}M_{1-X}, where 1>X≧1/2 and M is Mn, Fe, Co, or Ni.

2. The lithium secondary battery according to claim 1, wherein the negative electrode binder be heat-treated at a temperature higher than the melting point of the negative electrode binder.

3. The lithium secondary battery according to claim 1, wherein the negative electrode binder be heat-treated at a temperature higher than the glass transition temperature of the negative electrode binder.

4. The lithium secondary battery according to claim 2, wherein the negative electrode binder is PVdF.

5. The lithium secondary battery according to claim 3, wherein the negative electrode binder is PVdF.

6. The lithium secondary battery according to claim 1, wherein the Sn-based particulate negative electrode active material is made of an intermetallic compound represented as Co_{1-Y}Sn_{Y}, where 2/3≧Y≧1/2.

7. The lithium secondary battery according to claim 1, wherein the Sn-based particulate negative electrode active material is made of an intermetallic compound represented as Co_{1-Y}Sn_{Y}, where 2/3≧Y≧1/2.

8. The lithium secondary battery according to claim 3, wherein the Sn-based particulate negative electrode active material is made of an intermetallic compound represented as Co_{1-Y}Sn_{Y}, where 2/3≧Y≧1/2.

9. The lithium secondary battery according to claim 1, wherein the negative electrode current collector is made of an alloy foil containing 90 mass % or more of copper.

10. The lithium secondary battery according to claim 1, wherein the negative electrode current collector has a surface roughness Ra of 0.2 μm or greater.

11. An electrode for a lithium secondary battery, comprising:
a negative electrode current collector; and
a negative electrode mixture layer formed on a surface of the negative electrode current collector, the negative electrode mixture layer containing a Sn-based particulate negative electrode active material and a negative electrode binder, wherein:
the negative electrode binder is melt-bonded to the Sn-based particulate negative electrode active material and/or the negative electrode current collector; and the Sn-based particulate negative electrode active material is made of an intermetallic compound represented as Sn_{X}M_{1-X}, where 1>X≧1/2 and M is Mn, Fe, Co, or Ni.

12. A method of manufacturing a lithium secondary battery, comprising:
forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni to a surface of a negative electrode current collector, drying the negative electrode mixture slurry with the current collector and pressure-rolling the negative electrode mixture with the current collector;
heating the negative electrode mixture layer at a process temperature higher than the melting point of the negative electrode binder to prepare a negative electrode;
preparing an electrode assembly comprising the negative electrode and the positive electrode; and
thereafter enclosing the electrode assembly and a non-aqueous electrolyte in a battery case.

13. A method of manufacturing a lithium secondary battery, comprising:
forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni to a surface of a negative electrode current collector, drying the negative electrode mixture slurry with the current collector and pressure-rolling the negative electrode mixture with the current collector;
heating the negative electrode mixture layer at a process temperature higher than the glass transition temperature of the negative electrode binder to prepare a negative electrode;
preparing an electrode assembly comprising the negative electrode and the positive electrode; and
thereafter enclosing the electrode assembly and a non-aqueous electrolyte in a battery case.

14. The method according to claim 12, wherein the process temperature is lower than the melting point of the intermetallic compound and the melting point of the negative electrode current collector.

15. The method according to claim 13, wherein the process temperature is lower than the eutectic point of the intermetallic compound.

16. The method according to claim 12, wherein the process temperature is lower than the eutectic point of the intermetallic compound.

17. The method according to claim 13, wherein the process temperature is lower than the eutectic point of the intermetallic compound.

18. A method of manufacturing a negative electrode for a lithium secondary battery, comprising:
forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni, to a surface of a negative electrode current collector, drying the negative electrode mixture slurry with the current collector and pressure-rolling the negative electrode mixture with the current collector; and
heating the negative electrode mixture layer at a process temperature higher than the melting point of the negative electrode binder.

19. A method of manufacturing a negative electrode for a lithium secondary battery, comprising:
forming a negative electrode mixture layer by applying a negative electrode mixture slurry containing a negative electrode binder and a Sn-based particulate negative electrode active material made of an intermetallic compound represented as Sn_{X}M_{1-X}, where 1>X≧1/2 and M is Mn, Fe, Co, or Ni, to a surface of a negative electrode current collector, drying the negative electrode mixture slurry with the current collector and pressure-rolling the negative electrode mixture with the current collector; and
heating the negative electrode mixture layer at a process temperature higher than the glass transition temperature of the negative electrode binder.
